(19) United States
(12) Patent Application Publication
(10) Pub. No.: US 2023/0307920 A1
(43) Pub. Date: Sep. 28, 2023

(54) METHOD AND APPARATUS FOR MANAGING DISTRIBUTED ENERGY RESOURCES

(71) Applicant: Enphase Energy, Inc., Petaluma, CA (US)

(72) Inventor: Raghuveer R. BELUR, Los Altos Hills, CA (US)

(21) Appl. No.: 18/125,296

(22) Filed: Mar. 23, 2023

Related U.S. Application Data
(60) Provisional application No. 63/323,242, filed on Mar. 24, 2022.

(51) Int. Cl. H02J 3/38; H02J 3/32

(52) U.S. Cl. CPC H02J 3/381; H02J 3/32; H02J 2203/10; H02J 2310/52; H02J 2310/60

(57) ABSTRACT

A method and apparatus for managing distributed energy resources is provided herein. For example, an apparatus for managing distributed energy resources comprises a first electrical area comprising: at least one power producing distributed energy resource (PDER); at least one power consuming distributed energy resource (CDER); and a controller configured to monitor parameters of the at least one CDER and the at least one PDER, receive second electrical area parameters from a second electrical area, and control the at least one PDER and the at least one CDER based upon the parameters of the at least one CDER and the at least one PDER and the second electrical area parameters.

### CROSS-REFERENCE TO RELATED APPLICATION

The present application claims the benefit of and priority to U.S. Provisional Application Ser. No. 63/323,242, filed on Mar. 24, 2022, the entire contents of which is incorporated herein by reference.

### BACKGROUND

### Field

Embodiments of the present disclosure generally relate to energy production and consumption systems that utilize distributed energy resources and, in particular, to a method and apparatus for managing distributed energy resources.

### Description of the Related Art

A solar energy generation and storage system (Power Production Distributed Energy Resources (PDERs) typically comprises a number of components including, but not limited to, a plurality of solar panels, one or more power inverters, a storage element and a service panel. The solar panels are arranged in an array and positioned to maximize solar exposure. Each solar panel or small groups of panels may be coupled to an inverter (so-called micro-inverters) or all the solar panels may be coupled to a single inverter. The inverter(s) convert the DC power produced by the solar panels into AC power. The AC power is coupled to the service panel for use by a facility (e.g., home or business), supplied to the power grid, and/or coupled to a storage element such that energy produced at one time is stored for use at a later time. Storage elements may be one or more of batteries, fly wheels, hot fluid tank, hydrogen storage or the like. The most common storage element is a battery pack (i.e., a plurality of battery cells) having a bidirectional inverter coupled to the service panel to supply the batteries with DC power as well as allow the batteries to discharge through the inverter to supply AC power to the facility when needed.

A number of components within the facility to which the generation and storage system is connected consume the generated power, e.g., load or consumption components (Power Consuming Distributed Energy Resources (CDERs)) such as appliances, electric vehicles, etc. Together PDERs and CDERs form an electrical area. Typically, the electrical area may be controlled by a controller to control loads and sources to locally balance energy production and consumption. Each electrical area locally operates without regard for neighboring electrical areas (neighboring homes and businesses having controlled CDERs and PDERs). As such, although an individual electric area may operate properly, but over an entire region comprising many electrical areas, the region may not optimally operate. This especially is an issue as more and more electric vehicles (EVs) are charged across various electric areas and move form area to area.

Therefore, there is a need for improved method and apparatus for managing distributed energy resources across a plurality of electrical areas.

### SUMMARY

In accordance with at least some aspects of the disclosure, there is provided an apparatus for managing distributed energy resources. The apparatus comprises a first electrical area comprising: at least one power producing distributed energy resource (PDER); at least one power consuming distributed energy resource (CDER); and a controller configured to monitor parameters of the at least one CDER and the at least one PDER, receive second electrical area parameters from a second electrical area, and control the at least one PDER and the at least one CDER based upon the parameters of the at least one CDER and the at least one PDER and the second electrical area parameters.

In accordance with at least some aspects of the disclosure, there is provided a method of managing distributed energy resources. The method comprises monitoring parameters of at least one CDER and at least one PDER; receiving second electrical area parameters from a second electrical area; and controlling the at least one PDER and at least one CDER based upon the parameters of the at least one CDER and the at least one PDER and the second electrical area parameters.

In accordance with at least some aspects of the disclosure, there is provided a nontransitory computer readable storage medium having instructions stored thereon that when executed by a processor performs a method of managing distributed energy resources. The method comprises monitoring parameters of at least one CDER and at least one PDER; receiving second electrical area parameters from a second electrical area; and controlling the at least one PDER and at least one CDER based upon the parameters of the at least one CDER and the at least one PDER and the second electrical area parameters.

### BRIEF DESCRIPTION OF THE DRAWINGS

So that the manner in which the above recited features of the present disclosure can be understood in detail, a particular description of the disclosure, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of a distributed energy resource management system in accordance with at least one embodiment of the disclosure;

FIG. 2 is a block diagram of an electrical area in accordance with an embodiment of the disclosure;

FIG. 3 is a flowchart of a method for operating the electrical area of FIG. 2 in accordance with an embodiment of the disclosure; and

FIG. 4 is a block diagram of a hierarchical management system for managing a plurality of electrical areas in accordance with an embodiment of the disclosure.

### DETAILED DESCRIPTION

Embodiments of the present disclosure comprise apparatus and methods for distributed energy resources. Embodiments of the disclosure comprise defining electrical areas (e.g., homes, business, apartment complexes, housing complexes, etc.) containing at least one controller coupled to at least one power consuming distributed energy resource (CDER) (e.g., electric appliances, electric vehicles, electric machinery, etc.) and at least one power producing distributed energy resource (PDER) (e.g., electric storage, solar panels, wind turbines, fuel cells, etc.). Since electric storage and electric vehicles may extract energy for storage as well as disgorge energy, these components may be viewed as behaving as both CDER and PDER. The controller(s) of a given electric area are capable of communicating to controller(s) in other electric areas. As such, local electric areas communicate their electricity consumption and production parameters to neighboring electric areas to ensure that the electric areas cooperate to maintain a stable power grid. In an alternative embodiment, the electric areas may be organized into a plurality of virtual areas that are interconnected through a distributed system operator. The alternative embodiment produces a hierarchical energy management structure.

In some embodiments, the system may treat an electric vehicle (EV) and/or electric storage as both a CDER and a PDER. In some instances, the EV and/or storage may be charging and operate as a load (i.e., a CDER), but, in other instances, the EV and/or storage may discharge into the electrical area and operate as a source (i.e., a PDER). Public and private charging station locations for EVs form a PDER within an electrical area. These electrical areas may communicate to EVs to understand the EV state of charge (SoC) and the amount of power required to charge the EV or the amount of power available from the EV. The value of the energy for charging or discharging may be made available to the EV such that the EV may “shop” for the best price for charging and discharging. In this manner, the EV operates as a mobile electrical area and interacts with other electrical areas.

For example, an EV may charge overnight using a home electrical area to charge for the PDERs storage or the power grid. The home electrical area communicates to other electrical areas to determine the optimal way to charge the EV. When the EV disconnects from the home electrical area, the EV may drive to an office electrical area and connect to the PDER. In mid-afternoon, the office electrical area may have a high HVAC load and require additional electrical energy. The additional energy may be extracted from the EV to augment the office electrical area PDERs. The EV account would be credited for the cost of the energy at peak rates. The EV communicates with the office electrical area as well as neighboring electrical areas to determine the optimal time to recharge the EV, if necessary. The EV may be recharged towards the end of the day before being driven to the home electrical area. As mentioned above, the EV forms a mobile electrical area.

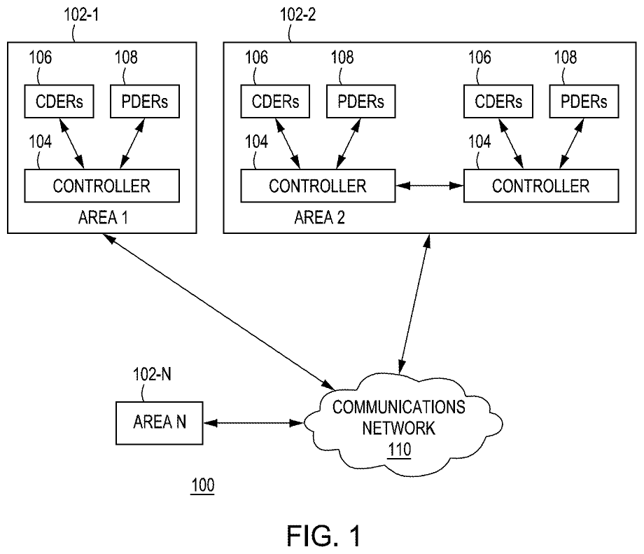

FIG. 1 is a block diagram of a distributed energy resource management system 100 (e.g., an energy production and consumption system) comprising a plurality of electrical areas 102-1, 102-2, . . . 102-N (where N is an integer) coupled to one another via a communications network 110 (e.g., the Internet). Each electrical area 102 comprises a controller 104 (or a plurality of controllers) coupled to CDERs 106 and PDERs 108. In some embodiments, the electrical areas 102 (e.g., the electrical area 102-2) may comprise a plurality of controller 104, each coupled to the CDERs 106 and PDERs 108. Multiple controller areas may be used in, for example, housing complexes, while single controller areas may include single family homes or individual businesses.

Each controller 104 communicates with CDERs 106 and PDERs 108 to monitor various parameters regarding the current operational state of the CDERs 106 and PDERs 108. For example, the controller 104 monitors the amount of power being generated and/or stored by the PDERs 108 and the amount of power being consumed by the CDERs 106. Information regarding the operation of an electrical area 102-1 is shared with controllers 104 in other areas 102-N via messages sent through the communications network 110. In some embodiments, controllers 104 within an electrical area (e.g., electrical area 102-2) may communicate messages directly with one another rather than through the communications network 110.

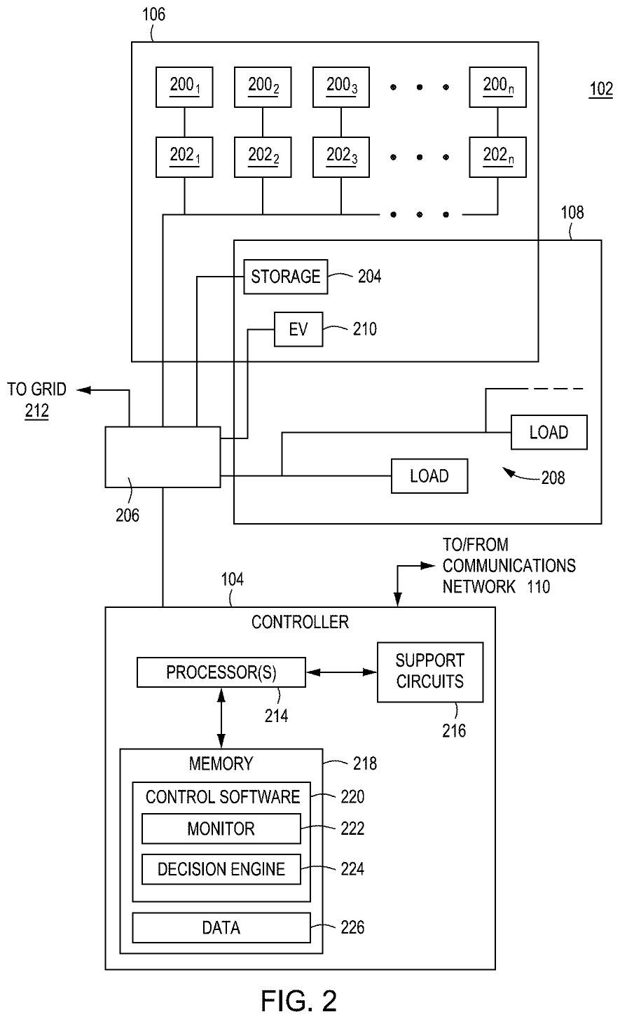

The information (parameters) that is shared amongst controllers 104 may comprise at least one of an amount of energy being produced, amount of energy being stored, amount of energy being consumed, state of charge regarding energy storage, state of charge of electric vehicles, near-term projections of energy production or consumption, etc. In response to receiving a message, a controller may alter the behavior of the CDERs 106 or PDERs 108 to assist with grid stability. For example, if a controller 104 indicates it is charging an electric vehicle with a low state of charge (e.g., requiring a substantial amount of energy), may cause a neighboring area to supply energy to the grid from its PDERs to ensure the grid is not overloaded by energy demand. The details of the structure and operation of an electrical area 102 is described with respect to FIG. 2 below.

The electrical area 102 comprises PDERs 108 such as a solar system (e.g., solar panels 200₁, 200₂, 200₃, . . . 200ₙ coupled to inverters 202₁, 202₂, 202₃, . . . 202ₙ) and storage devices 204 (e.g., battery, thermal, kinetic, etc.). A service panel 206 couples the PDERs to one another. The service panel 206 is also coupled to the CDERs (e.g., a plurality of loads 208). The loads 208, in a residential application, may comprise washer, dryer, refrigerator, air conditioner, hot water heater, electric vehicle charger, and/or any other electricity consuming device in the household. The loads 208, in an industrial application, may comprise electric motors, heating systems, air conditioning systems, refrigerators, freezers, and/or any other electricity consuming device generally used in an industrial setting. The CDERs 106 may also include one or more electric vehicles 210. The service panel 206 may also be coupled to the grid 212, such that, energy may be consumed from the grid 212 or sourced to the grid 212, as necessary. Alternatively, as is described in detail below, the service panel may include or may be replaced by and energy management device (e.g., a smart switch) that controls the flow of energy throughout the electrical area 102.

Although FIG. 1 is a distributed generator having a single solar panel coupled to a single inverter (i.e., micro-inverter), this depiction is not meant to limit the scope of the disclosure. For example, embodiments of the disclosure may also be used with distributed generators having a plurality or more solar panels coupled to one or more inventers. In other system, the distributed generator may be formed by solar panels that are each coupled to a DC optimizer and the optimizers are coupled to at least one inverter to produce AC power. Furthermore, distributed generators may include other forms of energy generation such as wind turbines arranged on a so-called “wind farm.” Similarly, energy storage in a battery-based storage system is described as an example of the type of storage whose capacity is estimated using embodiments of the disclosure; however, other forms of energy storage may be used such as fly wheel(s), hot fluid tank(s), hydrogen storage system(s), pressurized gas storage system(s), pumped storage hydropower, fuel cells, or the like.

Since electric storage and EVs both extract energy from the system for storage as well as disgorge energy to the system, they may be considered to be both PDER and CDER depending on their current status. When charging, EVs and storage are considered CDERs and, when discharging into the system, they may be considered to be PDERs. As noted below, an EV may be considered a mobile CDER/PDER because it may store energy at one location and discharge the energy at another location.

A controller 104 is also coupled to the service panel 206 and monitors the state of the CDERs 106 and PDERs 108. Such communication may occur through wireless or wired connections such as power line communications (PLC), WiFi, ZigBee, Bluetooth, and the like.

The controller 104 comprises a processor 214 (or a plurality of processors), support circuits 216 and memory 218. The processor 214 may be any form of processor or combination of processors including, but not limited to, central processing units, microprocessors, microcontrollers, field programmable gate arrays, graphics processing units, and the like capable of executing software instructions to cause the controller to perform the functions described herein. The support circuits 216 may comprise well-known circuits and devices facilitating functionality of the processor(s). The support circuits 216 may comprise one or more of, or a combination of, power supplies, clock circuits, communications circuits, cache, displays, and/or the like. The support circuits facilitate communications with the CDERs and PDERs as well as the communications network 110.

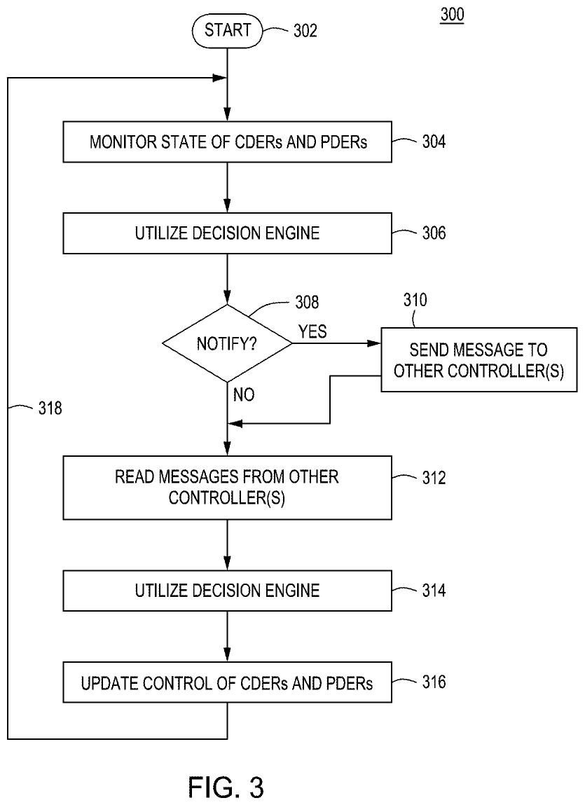

The memory 218 comprises one or more forms of non-transitory computer readable media including one or more of, or any combination of, read-only memory or random-access memory. The memory 218 stores software and data including, for example, control software 220 and data 226. The control software 220 comprises a monitoring module 222 and a decision engine 224. The control software 220 may comprise software instructions that, when executed by the processor 214, cause the controller to monitor the status of the CDERs and PDERs as well as share information with other controllers in other electrical areas. The monitoring module 222 accesses and stores the CDER and PDER status information and stores the information as data 226. The decision engine 224 determines, based on the status information and messages from other controllers, how to control the CDERs and PDERs in the controller's area 102. The decision engine 224 may operate on a rule driven basis or may use machine learning. Details of the operation of the control software 220 is described with respect to FIG. 3 below.

FIG. 3 is a flowchart of a method 300 for operating the control software when executed by the processor(s) of a controller in accordance with an embodiment of the disclosure. Each block of the flow diagrams below may represent a module of code to execute and/or combinations of hardware and/or software configured to perform one or more processes described herein. Though illustrated in a particular order, the following figure is not meant to be so limiting. Any number of blocks may proceed in any order (including being omitted) and/or substantially simultaneously (i.e., within technical tolerances of processors, etc.) to perform the operations described herein.

The method 300 begins at 302 and proceeds to 304 where the method 300 monitors the state (e.g., monitor parameters) of the CDERs and PDERs that are coupled to the controller. The state information may comprise at least one of an amount of energy being produced, amount of energy being stored, amount of energy being consumed, state of charge regarding energy storage, state of charge of electric vehicles, near-term projections of energy production or consumption, etc.

At 306, the method 300 utilizes the decision engine to analyze the state information. Based upon the local CDER and PDER state information, the decision engine makes (determines) a preliminary decision regarding the control of the PDERs and CDERs. The decision process may be rule driven (i.e., given the current state information compared to a predefined set of rules, determine a control decision). For example, at 306, the controller is configured to compare the at least one CDER and the at least one PDER with a predefined set of rules to control the at least one PDER and the at least one CDER. Such rule driven decision making may utilize a look up table that uses the state information as input data. For example, an electric vehicle may be charging with a low state of charge (i.e., requiring a large amount of energy) and the storage device may be fully charged. Thus, a local decision may be to utilize the stored energy to charge the vehicle. However, if the vehicle was plugged in for charging at sundown and the stored energy was about to be used for powering other appliances at night, a decision may be to use grid supplied energy to charge the vehicle.

At 308, the method 300 comprises determining if a message comprising the parameters of the at least one CDER and the at least one PDER needs to be sent to the second electrical area, and if the message needs to be sent to the second electrical area, the controller is further configured to communicate the message to the second electrical area. For example, the controller queries whether a message should be sent to other controllers to regarding the state of the CDERs and PDERs as well as the current control decision. If a message is to be sent, the method 300 proceeds to 310 where a message is sent to other controller(s). In the example above, because the controller has decided to use grid energy to charge the vehicle, neighboring electrical areas may want to respond by releasing energy from storage onto the grid or reducing their current use of energy. As such, the grid will not be overloaded by a large number of electric vehicle owners all charging their vehicles at the same time. In this manner, energy management across a regional portion of the grid is managed in a distributed manner. The command and control structure for this embodiment is flat. The size of a regional area may be defined by geography, distance, or by the capacity of the grid itself.

After a message is sent or a decision is made not to send a message, the method continues to 312 where the method 300 reads message(s) from other controllers. At 312, the content of the message(s) is applied to the decision engine to determine whether the current parameters of the local PDERs and CDERs require adjustment in view of the needs of other electrical areas. The decision engine operates in the same manner as described above—either applying an LUT or machine learning to determine a control decision. At 316, the method 300 updates the CDER and PDER control parameters, as needed. The method 300 continues along path 318 to continue monitoring the state of the local electrical area's PDERs and CDERs.

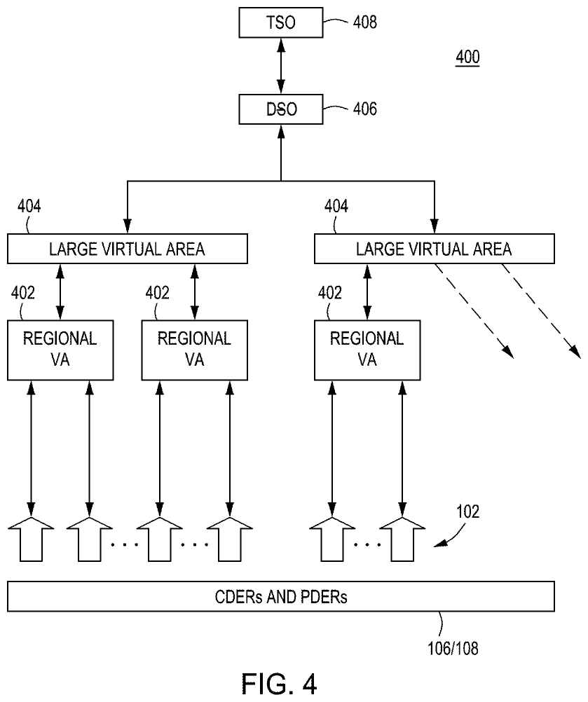

FIG. 4 depicts a block diagram of a system 400 (e.g., an energy management system) in accordance with an alternative embodiment of the disclosure. The system 400 extends the flat, distributed energy resource management system of FIG. 1 into a hierarchical system, where electrical areas 102 (e.g., local electrical areas) are grouped into regional virtual areas 402 and large virtual areas 404 that ultimately communicate with a DSO 406 (distribution system operator). The DSO 406 communicates with a transmission system operator (TSO) 408 that operates a power grid supplying energy to the electrical areas 102.

The system architecture of system 400 is very scalable—as new local electrical areas 102 are added, or new CDERs and/or PDERs are added to existing electrical areas, the system 400 naturally accommodates these additions and maximizes the opportunities available. The system 400 is also secure and therefore reliable—each local and virtual electric area is operated by a stand-alone controller that is responsible for its own security and only in communication with (not depending on) any higher-level of control. Similarly, because some control is performed locally (or at an intermediate level) there is often no information being transmitted up through several layers where there is no necessity, i.e., information is communicated on a need to know basis. The system architecture is also less expensive than the current grid architecture because embodiments of the new architecture depend on local controllers within each electrical area as opposed to a grid-wide “demand-response” type protocol in which a threshold is met and a unique demand response event is attended to. Demand response is therefore fluid and dynamic, occurring continuously, as the DERs and energy impact of each electrical area changes.

Here multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the disclosure presented herein. The disclosure is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g., A, AB, AC, ABC, ABB, etc.). When “and/or” is used, it should be understood that the elements may be joined in the alternative or conjunctive.

While the foregoing is directed to embodiments of the present disclosure, other and further embodiments of the disclosure may be devised without departing from the basic scope thereof, and the scope thereof is determined by the claims that follow.

1. An apparatus for managing distributed energy resources, comprising:
a first electrical area comprising:
at least one power producing distributed energy resource (PDER);
at least one power consuming distributed energy resource (CDER); and
a controller configured to monitor parameters of the at least one CDER and the at least one PDER, receive second electrical area parameters from a second electrical area, and control the at least one PDER and the at least one CDER based upon the parameters of the at least one CDER and the at least one PDER and the second electrical area parameters.

2. The apparatus of claim 1, wherein the parameters of the at least one CDER and the at least one PDER comprise at least one of an amount of energy being produced, amount of energy being stored, amount of energy being consumed, state of charge regarding energy storage, state of charge of electric vehicles, or near-term projections of energy production or consumption.

3. The apparatus of claim 1, wherein the controller is further configured to compare of the at least one CDER and the at least one PDER with a predefined set of rules to control the at least one PDER and the at least one CDER.

4. The apparatus of claim 3, wherein the predefined set of rules is stored in a look up table that uses the parameters of the at least one CDER and the at least one PDER as input data.

5. The apparatus of claim 1, wherein the controller is further configured to determine if a message comprising the parameters of the at least one CDER and the at least one PDER needs to be sent to the second electrical area, and if the message needs to be sent to the second electrical area, the controller is further configured to communicate the message to the second electrical area.

6. The apparatus of claim 5, wherein in response to receiving the message from the controller, the second electrical area is configured to at least one of release energy from storage onto a grid or reduce a current use of energy.

7. A method of managing distributed energy resources, comprising:
monitoring parameters of at least one CDER and at least one PDER;
receiving second electrical area parameters from a second electrical area; and
controlling the at least one PDER and at least one CDER based upon the parameters of the at least one CDER and the at least one PDER and the second electrical area parameters.

8. The method of claim 7, wherein the parameters of the at least one CDER and the at least one PDER comprise at least one of an amount of energy being produced, amount of energy being stored, amount of energy being consumed, state of charge regarding energy storage, state of charge of electric vehicles, or near-term projections of energy production or consumption.

9. The method of claim 7, further comprising comparing the parameters of the at least one CDER and the at least one PDER to a predefined set of rules for controlling the at least one PDER and the at least one CDER.

10. The method of claim 9, wherein the predefined set of rules is stored in a look up table that uses the parameters of the at least one CDER and the at least one PDER as input data.

11. The method of claim 7, further comprising determining if a message comprising the parameters of the at least one CDER and the at least one PDER needs to be sent to the second electrical area, and if the message needs to be sent to the second electrical area, further comprising communicating the message to the second electrical area.

12. The method of claim 11, wherein in response to the receiving the message, further comprising, at the second electrical area, releasing energy from storage onto a grid or reducing a current use of energy.

13. A nontransitory computer readable storage medium having instructions stored thereon that when executed by a processor performs a method of managing distributed energy resources, comprising:
monitoring parameters of at least one CDER and at least one PDER;
receiving second electrical area parameters from a second electrical area; and
controlling the at least one PDER and at least one CDER based upon the parameters of the at least one CDER and the at least one PDER and the second electrical area parameters.

14. The nontransitory computer readable storage medium of claim 13, wherein the parameters of the at least one CDER and the at least one PDER comprise at least one of an amount of energy being produced, amount of energy being stored, amount of energy being consumed, state of charge regarding energy storage, state of charge of electric vehicles, or near-term projections of energy production or consumption.

15. The nontransitory computer readable storage medium of claim 13, further comprising comparing the parameters of the at least one CDER and the at least one PDER to a predefined set of rules for controlling the at least one PDER and the at least one CDER.

16. The nontransitory computer readable storage medium of claim 15, wherein the predefined set of rules is stored in a look up table that uses the parameters of the at least one CDER and the at least one PDER as input data.

17. The nontransitory computer readable storage medium of claim 13, further comprising determining if a message comprising the parameters of the at least one CDER and the at least one PDER needs to be sent to the second electrical area, and if the message needs to be sent to the second electrical area, further comprising communicating the message to the second electrical area.

18. The nontransitory computer readable storage medium of claim 17, wherein in response to the receiving the message, further comprising, at the second electrical area, releasing energy from storage onto a grid or reducing a current use of energy.
